(19) United States
(12) Patent Application Publication
(10) Pub. No.: US 2010/0002779 A1
(43) Pub. Date: Jan. 7, 2010

(54) MECHANISM FOR THE MANAGEMENT OF RECEIVERS/DECODERS CONNECTIONS

(75) Inventors: Patrick Leprince, Chantepie (FR); David Libault, Paris (FR)

Correspondence Address: Robert D. Shedd, Patent Operations;THOMSON Licensing LLC, P.O. Box 5312, Princeton, NJ, 08543-5312, US

(73) Assignee: Thomson Licensing, Boulogne-Billancourt (FR)

(21) Appl. No.: 12/310,300

(22) PCT Filed: Aug. 17, 2007
(86) PCT No.: PCT/FR2007/051827

§ 371 Date: Feb. 20, 2009

(30) Foreign Application Priority Data
Aug. 22, 2006 (FR) 0653422
Sep. 19, 2006 (FR) 0653822

(51) Int. Cl. H04B 7/00; H04L 27/00

(52) U.S. Cl. 375/259; 455/69

(57) ABSTRACT

The present invention relates to a communication device, comprising modulation and demodulation means, connected to a communication network and to at least one receiver/decoder, comprising means of selecting among the following different possibilities, depending on the available bandwidth on the communication network, upon receipt of a request originating from said receiver/decoder: transmit the request unmodified to said network; or modify the request in order to request a feed of lesser quality; or refuse to transmit the request to said network and broadcast to the receiver/decoder a preconfigured multimedia file. The present invention also relates to a communication method.

### SCOPE OF THE INVENTION

The present invention relates to the domain of Information and Communication Technologies.

The present invention more specifically relates to a mechanism for the management of receiver/decoder connections.

### PRIOR ART

The present invention relates to the case in which multiple receiver/decoders or Set-Top Boxes (STBs), are associated with an ADSL (Asymmetric Digital Subscriber Line) gateway. A mechanism must be implemented that enables the refusal of the connection of a receiver/decoder to a multicast stream if the ADSL bandwidth used by the transmitted stream on the other receiver/decoders is too large.

One solution could consist in the gateway “spying on” the IGMP (Internet Group Management Protocol) packets transmitted by each receiver/decoder, then using the service plan describing the characteristics of each stream, calculating the total bandwidth used.

To receive a multicast stream, a receiver/decoder must transmit a “join” IGMP packet in multicast. This packet is reflected along the chain of multicast routers so that one router directs the requested stream to the port of another router where the request was received. No acknowledgement of this “join” packet is transmitted in response to the receiver/decoder.

If the gateway decides to intercept this IGMP packet and block it so as not to overload the bandwidth, there is no means to signify the stream absence to the receiver/decoder. The TV screen remains black.

The prior art knows, through the US patent application No. US 2003/0035378 (Motorola), a method and an apparatus for the management of multicast data in an IP sub-network. A communication system, in an embodiment, comprises receiver/decoders that can observe the sub-network to which they are coupled. A multicast router couples one or more group(s), such as video programme groups, to the receiver/decoders as requested by the receiver/decoders. If a receiver/decoder leaves a first group, for example, and thus transmits a “leave” message to the router, the other receiver/decoder(s) know(s) that it or they must transmit a “join” message if it (or they) subscribe(s) to this first group. Hence, the router knows immediately that it must couple this first group to the sub-network.

The prior art also knows, through the US patent application No. US 2005/237952 (Marconi Communications), a method and a device for conferences with bandwidth control. This document does not describe any communication device comprising means for selecting between the following different possibilities, depending on the available bandwidth on the communication network, upon reception of a request from a receiver/decoder:
transmit said request to the communication network without any modification; or
modify the request to ask for a stream of lesser quality or
refuse to transmit the request to said network and communicate to the receiver/decoder a preconfigured multimedia file.

The prior art also knows, through the technical article “Multicasting in Differentiated Service Domains” (Baijan Yang et al, IEEE Global Telecommunications Conference, 17 Nov. 2003), solutions for managing the quality of service in communication networks. This document does not describe any communication device comprising means for selecting between the following different possibilities, depending on the available bandwidth on the communication network, upon reception of a request from a receiver/decoder:
transmit said request to the communication network without any modification; or
modify the request to ask for a stream of lesser quality; or
refuse to transmit the request to said network and communicate to the receiver/decoder a preconfigured multimedia file.

The prior art also knows, from the US patent application No. US 2006/146857, an admission control mechanism for multicast receivers. This document does not describe any communication device comprising means for selecting between the following different possibilities, depending on the available bandwidth on the communication network, upon reception of a request from a receiver/decoder:
transmit said request to the communication network without any modification; or
modify the request to ask for a stream of lesser quality; or
refuse to transmit the request to said network and communicate to the receiver/decoder a preconfigured multimedia file.

### SUMMARY OF THE INVENTION

The present invention intends to overcome the drawbacks of the prior art by proposing a solution for avoiding that the screen remains black, when no stream is transmitted to the receiver/decoder, when the bandwidth is at risk of being overloaded.

For this purpose, the present invention relates to, in its most generally accepted sense, a communication device, connected on one side to a communication network and on the other side to at least one receiver/decoder, characterized in that it comprises means for selecting between the different following possibilities, depending on the available bandwidth on the communication network, upon reception of a request from said receiver/decoder:
transmit said request to the communication network without any modification; or
modify the request to ask for a stream of lesser quality or
refuse to transmit the request to said network and communicate to the receiver/decoder a preconfigured multimedia file.

Preferably, said device also comprises means for operating a service plan containing all the multicast addresses and at least one characteristic of the corresponding streams, for example the programme name, the codecs used or the bandwidth used.

Advantageously, said device also comprises means for operating a table of streams being received on each of the receiver/decoders connected to said communication device, said request being established from the viewed IGMP requests.

Preferably, said device comprises means for computing the used bandwidth of the communication network and means for computing the communication network bandwidth that is required for the reception of a new on-demand stream of a new IGMP request, from the service plan and the streams table.

Advantageously, said device is ADSL (Asymmetric Digital Subscriber Line) compatible.

According to an advantageous variant, said device has an URL (Uniform Resource Locator) in a configuration table and comprises means for retrieving said preconfigured multimedia file from said URL, and means for transmitting said multimedia file to said receiver/decoder in a multicast stream and in loop.

Preferably, the multimedia file is retrieved from said URL by means of a HTTP (Hypertext Transfer Protocol) protocol.

According to a particular embodiment, said device comprises means for formatting said multimedia file.

Said multimedia file can comprise video, animations and/or a vocal message.

Preferably, said device comprises means for modulating and demodulating.

The present invention also relates to a method of communication using a communication device, connected on one side to a communication network and on the other side to at least one receiver/decoder, characterized in that it comprises a step of selecting between the different following possibilities, depending on the available bandwidth on the communication network, upon reception of a request from said receiver/decoder:
transmit said request to the communication network without any modification; or
modify the request to ask for a stream of lesser quality or
refuse to transmit the request to said network and communicate to the receiver/decoder a preconfigured multimedia file.

Preferably, said method also comprises a step of operating a service plan containing all the multicast addresses and at least one characteristic of the corresponding streams, for example the programme name, the codecs used or the bandwidth used.

Advantageously, said method also comprises a step of operating a table of streams being received on each of the receiver/decoders connected to said communication device, said request being established from the viewed IGMP requests.

According to an embodiment, said method also comprises a step of computing the communication network bandwidth used and a step of computing the communication network bandwidth that is required for the reception of a new on-demand stream of a new IGMP request, from the service plan and the streams table.

According to an advantageous variant, said communication device has an URL (Uniform Resource Locator) in a configuration table and said method comprises a step of retrieving said preconfigured multimedia file from said URL and a step of transmitting said multimedia file to said receiver/decoder in a multicast stream and in loop.

The device and the method according to the present invention have numerous advantages:
they do not lead to any modification of the STB;
they do not require any additional computing capacity in the receiver/decoder (gateway), because there is no video encoding;
it is possible to define a different URL for each case of service refusal;
it is possible to add parameters in the HTTP (Hypertext Transfer Protocol) command transmitted by the gateway, enabling the HTTP server to generate “on the fly” the MPEG (Moving Picture Experts Group) information file; and
it is possible to perform a redirection to another stream with a less heightened bitrate and a lower resolution.

### BRIEF DESCRIPTION OF THE DRAWINGS

The invention will be better understood from the following description of an embodiment of the invention provided as an example by referring to the Figures, wherein:

FIGS. 1 and 3 illustrate an embodiment of the method according to the present invention;

FIG. 2 illustrates the communication device according to the present invention; and

FIG. 4 illustrates an IGMP packet.

### DETAILED DESCRIPTION OF THE EMBODIMENTS OF THE INVENTION

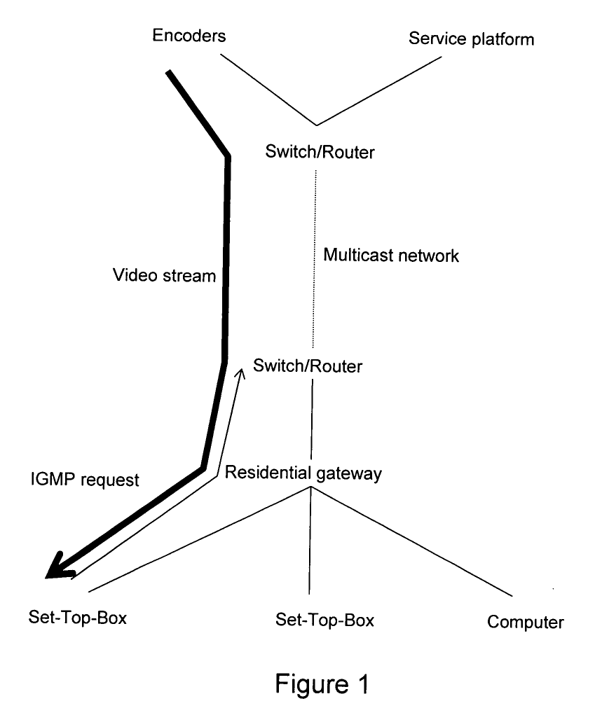

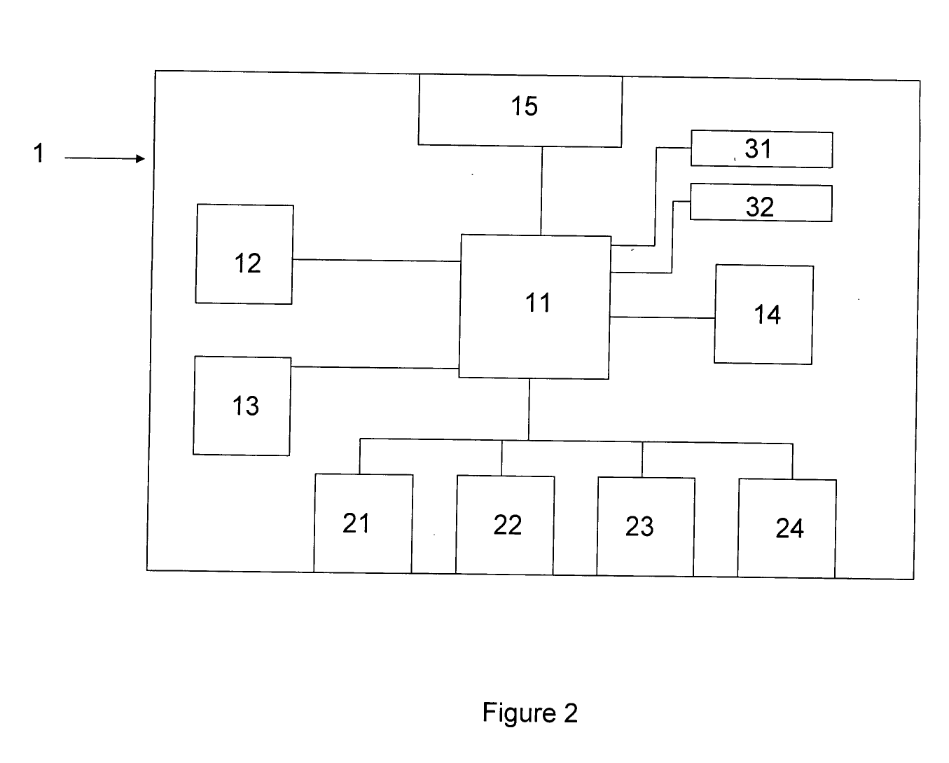

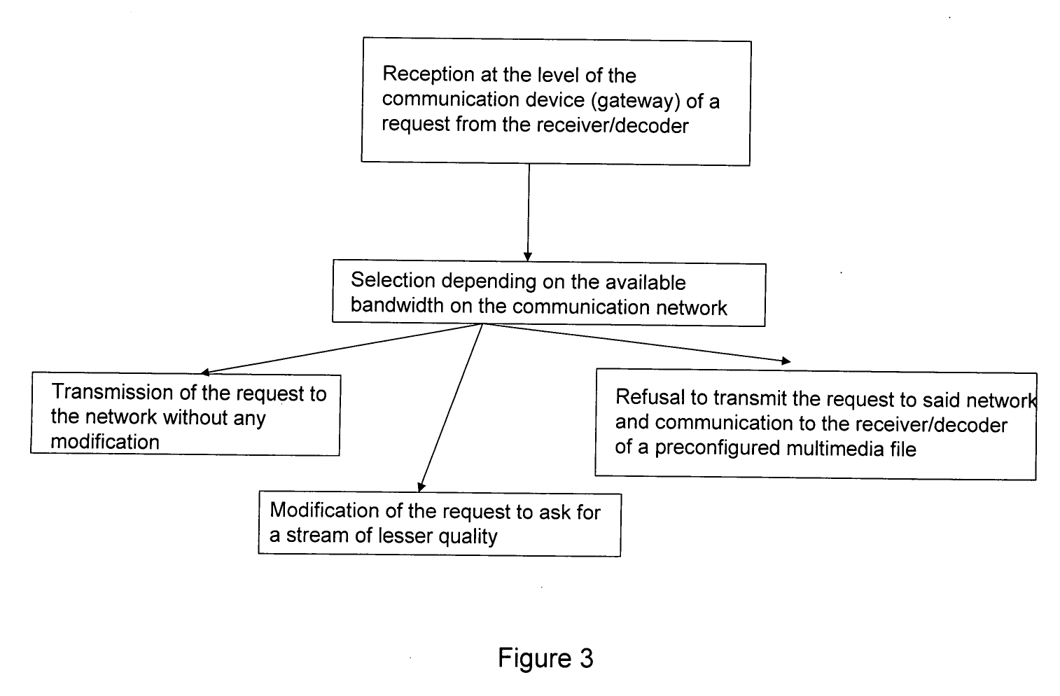

The communication device (or residential gateway) (1), shown on FIGS. 1 and 2, comprises:
a processor (11),
a Random Access Memory (31),
a storage memory (32),
an interface (15) to an external communication network, for instance a DSL interface, or an interface to a fibre optic network,
a W-LAN interface (14),
a DECT interface (12),
a Bluetooth interface (13), and
a plurality of Ethernet interfaces (21, 22, 23, 24).

The communication device (or residential gateway) (1), retrieves a “service plan” containing all of the multicast addresses and the characteristics of the corresponding streams (programme name, codecs and bandwidth used). The communication device maintains, from the IGMP requests viewed, a table of streams being received. From this table and the service plan, it computes the bandwidth used as well as the additional bandwidth that is required by a new IGMP request. From the bandwidth (for example ADSL) available, the communication device decides if this request should be transmitted without modification, redirected to a stream of lesser quality or refused by communicating a preconfigured multimedia file.

In an embodiment, the service plan reflects the available offer on the network in such a way as to address a park of several decoders in the user's residence. The offer can differ per user but the IP:Port address is unique per service.

The list of parameters associated with each service can change according the needs on the gateway.

In a particular embodiment, the service plan supplied to the gateway has the following form: Service Name, IP:Port service address, video coding type, audio coding type, service bitrate in Kbit/s.

In the context of the present invention, the gateway needs to know the video and possibly audio (if a vocal message is presented to the user) codec type, so that it can transmit information in the correct coding format. The gateway does not know the capacity of the decoder that calls it but it may be hypothesized that a decoder will not request a stream that does not correspond to its decoding capacity.

An example of a service plan is shown below:

TABLE 1
Example of a service plan

| | | Video | Audio | Service |
|---|---|---|---|---|
| Service | Service IP:Port | coding | coding | stream bitrate |
| name | address | type | type | in Kbit/s |
| TF1 | 232.0.1.21:8208 | H264-part10 | HE-AAC | 3500 |
| France 2 | 232.0.1.23:8208 | mpeg2 | HE-AAC | 3000 |
| Euronews | 232.0.1.25:8208 | H264-part10 | mpeg2 | 3300 |
| France 4 | 232.0.1.20:8208 | H264-part10 | HE-AAC | 3500 |

In practice, the service plan is not necessarily in table form.

The IGMP protocol transiting between the decoders (Set-Top Boxes) and the IGMP switches/routers enables the gateway (for example ADSL) to know for all of the items of equipment of its network that subscribe to these streams, to construct the table of streams in reception.

This table of streams comprises as a parameter an IP address corresponding to that of the stream to be received associated with an address of the destination receiver.

A stream table is therefore a list of pairs, these pairs comprising the IP address of the source stream and the IP address of the associated destination.

For example:

TABLE 1
Example of a stream table

| IP address of source stream | Destination IP address |
|---|---|
| 232.0.1.21:8208 | 178.3.2.97:8208 |
| 232.0.1.23:8208 | 178.3.2.63:8208 |

In practice, the stream table is not necessarily in table form.

The gateway, upon reception of a request from said receiver/decoder, can modify the request to ask for a lower quality stream. A description of the modifications implemented on the IGMP packets is provided here. The IGMP protocol is defined by the RFC 2236.

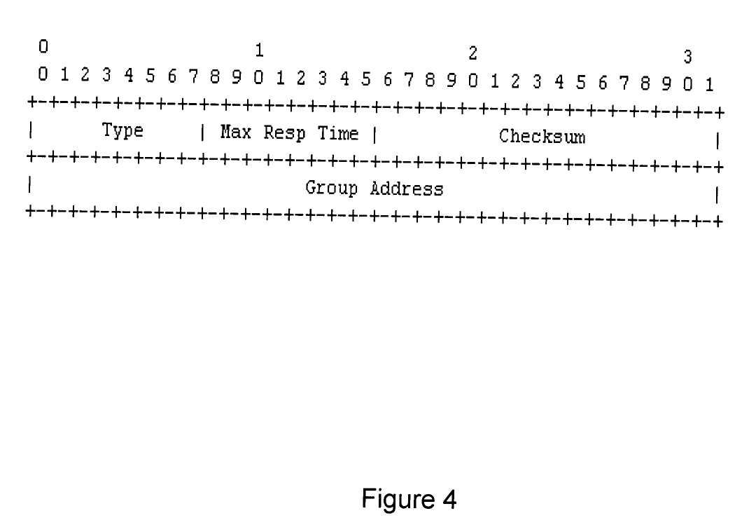

An IGMP packet is formed of 8 octets, and is presented in the form shown in FIG. 4.
Type describes the transmitted command
Max Resp Time describes the value of a timer used in the state machines implementing the protocol
Checksum enables verification of the integrity of the packet data
Group Address is the multicast address of the group to which the user wishes to subscribe or that he wishes to leave.

The gateway has resources that enable it to modify the IGMP requests received from the STB before transmitting them to the access network.

Hence, for example, for the STB to receive a stream of lower quality to that which was requested, the “Group Address” field of the Type Membership Report (0x16) command is modified from the service table.

Care must be taken to perform the same modification on the Type Leave Group (0x17) request.

Likewise, so that the operation is transparent for the STB, the requests that are received from the access network of Membership Query type (0x11) will be sent with the modified “Group Address” field to the STB.

The gateway can proceed as follows: not transmit the IGMP request to. the access network, and itself produce a video stream, possibly representing a fixed image that it transmits to the STB in the form of multicast packets.

In the following, the case where the IGMP request is refused and a multimedia file is communicated, is detailed.

The residential gateway, shown in FIG. 1, has in its configuration table an URL (“Uniform Resource Locator”) at which a video file is retrieved by HTTP. This video file, after formatting, is transmitted to the STB by gateway as for a multicast stream, in a loop. Hence, the ADSL bandwidth is not used during loop diffusion.

This file contains information explaining to the user the reason for the non-diffusion of the requested channel (for example: “Your ADSL subscription does not allow the simultaneous viewing of 2 High Definition streams. To increase the capacity of your line, go to: http://www.orange-ft.com”). It may also contain animations as it is a video file, as well as a vocal message.

The retrieval of the “service plan” enables the communication device to know the video and audio codecs used for each multicast address and hence to transmit a preconfigured multimedia file encoded in the same manner.

The invention is described in the preceding text as an example. It is understood that those skilled in the art are capable of producing variants of the invention without leaving the scope of the patent.

1. Communication device, connected on one side to a communication network and on the other side to at least one receiver/decoder, comprising means for selecting between the different following possibilities, depending on the available bandwidth on the communication network, upon reception of a request from said receiver/decoder:
transmit said request to the communication network without any modification; or
modify the request to ask for a stream of lesser quality; or
refuse to transmit the request to said network and communicate to the receiver/decoder a preconfigured multimedia file.

2. Communication device according to claim 1 further comprising means for operating a service plan containing all the multicast addresses and at least one characteristic of the corresponding streams, for example the programme name, the codecs used or the bandwidth used.

3. Communication device according to claim 1 further comprising means for operating a table of streams being received on each of the receiver/decoders connected to said communication device, said request being established from the viewed IGMP requests.

4. Communication device according to claim 2 comprising means for computing the used bandwidth of the communication network and means for computing the communication network bandwidth that is required for the reception of a new on-demand stream of a new IGMP request, from the service plan and the streams table.

5. Communications device according to claim 1, wherein it is ADSL (“Asymmetric Digital Subscriber Line”) compatible.

6. Communication device according to claim 1, wherein it has an URL (Uniform Resource Locator) in a configuration table and in that it comprises means for retrieving said preconfigured multimedia file from said URL and means for transmitting said multimedia file to said receiver/decoder in a multicast stream and in loop.

7. Communication device according to claim 6 wherein the multimedia file is retrieved from said URL using HTTP (“Hypertext Transfer Protocol”) protocol.

8. Communication device according to claim 6 comprising means for formatting said multimedia file.

9. Communication device according to claim 6 wherein said multimedia file comprises video.

10. Communication device according to claim 1 wherein said multimedia file comprises animations.

11. Communication device according to claim 1 wherein said multimedia file comprises a vocal message.

12. Communication device according to claim 1 comprising means for modulating and demodulating.

13. Method of communication using a communication device, connected on one side to a communication network and on the other side to at least one receiver/decoder, comprising a step of selecting between the different following possibilities, depending on the available bandwidth on the communication network, upon reception of a request from said receiver/decoder:
transmit said request to the communication network without any modification; or
modify the request to ask for a stream of lesser quality; or
refuse to transmit the request to said network and communicate to the receiver/decoder a preconfigured multimedia file.

14. Method of communication according to claim 13 wherein it also comprises a step of operating a service plan containing all the multicast addresses and at least one characteristic of the corresponding streams, for example the programme name, the codecs used or the bandwidth used.

15. Method of communication according to claim 13 also comprises also comprising a step of operating a table of streams being received on each of the receiver/decoders connected to said communication device, said request being established from the viewed IGMP requests.

16. Method of communication according to claims 14 also comprising step of computing the communication network bandwidth used and a step of computing the communication network bandwidth that is required for the reception of a new on-demand stream of a new IGMP request, from the service plan and the streams table.

17. Method of communication according to claim 13 wherein said communication device has an URL (Uniform Resource Locator) in a configuration table and in that said method comprises a step of retrieving said preconfigured multimedia file from said URL and a step of transmitting said multimedia file to said receiver/decoder in a multicast stream and in loop.
